(19) United States
(12) Patent Application Publication
(10) Pub. No.: US 2008/0117785 A1
(43) Pub. Date: May 22, 2008

(54) Method For Multiphoton-Ionizing Organic Molecule Supported By Solid Carrier

(75) Inventors: Shinzaburo Ito, Kyoto (JP); Hideo Ohkita, Kyoto (JP)

Correspondence Address: KRATZ, QUINTOS & HANSON, LLP, 1420 K Street, N.W., Suite 400, WASHINGTON, DC, 20005, US

(73) Assignee: Kyoto University, Kyoto-shi (JP)

(21) Appl. No.: 11/579,639

(22) PCT Filed: May 2, 2005
(86) PCT No.: PCT/JP05/08277

§ 371 Date: Jul. 31, 2007

(30) Foreign Application Priority Data
May 7, 2004 (JP) 2004-139018

(51) Int. Cl. G11B 7/00; B01D 5/00

(52) U.S. Cl. 369/53.31; 204/157.22

(57) ABSTRACT

A method for multiphoton-ionizing an organic molecule supported by a solid carrier according to the present invention is a method characterized in that the carrier supporting an organic molecule is irradiated with a laser light having a pulse width of less than 1 nanosecond. As a laser having a pulse width of less than 1 nanosecond, such femtosecond lasers as titanium-sapphire lasers, fiber lasers and ytterbium-tungsten lasers are desirable.

### TECHNICAL FIELD

The present invention relates to a method for efficiently multiphoton-ionizing an organic molecule supported by a solid carrier.

### BACKGROUND ART

When light having a low photon density is irradiated to a polymer solid in which a certain kind of dye molecule is dispersed, the dye molecule is excited to a higher energy-state by absorbing one photon, and it just returns to the ground state by emitting fluorescence and/or phosphorescence. Accordingly, no distinct change can be monitored for the polymer sample itself. This is because the dye molecule can not absorb an additional photon into it within an excited lifetime of the excited state in the case of irradiating light having a low photon density (refer to FIG. 18).

On the contrary when light having a high photon density such as a laser light is irradiated to a polymer sample, brilliant coloring can be monitored for the polymer sample after the light irradiation. This is caused by a radical cation generated from the dye molecule dispersed in the polymer solid that is excited to a higher-energy state by absorbing one photon and further absorbs a photon or photons within the excited lifetime, thereby obtaining, energy beyond the ionization potential (Ip) and ejecting an electron into the polymer solid (multiphoton ionization). Most of electrons ejected from the dye molecule are trapped in the polymer solid, and electrons trapped in the polymer solid stably exist even at room temperature when it does not exceed the glass transition temperature of the polymer material. A part of electrons trapped in the polymer solid recombine with the parent cations through electron tunneling (charge recombination) and, as the result of the recombination, the dye molecule again becomes an excited state to be quenched by emitting fluorescence and/or phosphorescence (charge recombination emission). Since a radical cation and an electron can not stably exist in a solution, recombination rate thereof is very large to make it impossible to monitor coloring. However, since recombination rate thereof is very small in a solid, period capable of monitoring the coloring extends as long as several months. FIG. 19 shows a scheme of two-photon ionization and charge recombination when a dye molecule dispersed in a polymer solid absorbs 2 photons.

Patent Document 1 proposes to apply multiphoton ionization to an optical recording utilizing reversibility of photochromism. Multiphoton ionization photochromism is essentially different from conventional photochromism based on the change of the absorption band through molecular isomerization reaction of a dye molecule in that the optical recording can be realized as a charge separation state based on the change of the absorption band caused by the change of the dye molecule into a radical cation through multiphoton ionization by light irradiation. Conventionally, as a recording medium for recording information using a laser light, such optical discs as. CD-R and CD-RW are known. Upon recording to these optical discs, a laser light having a wavelength of about 780 nm has been employed. Along with recent rapid progress of information processing technique, high capacity and high recording density of an optical recording medium is more and more strongly required. In order to satisfy the requirement, it is effective to narrow down a spatial spot of a laser light for use in information recording as small as possible. However, since it is impossible to narrow down it beyond the diffraction limit of the laser light, there exists an inevitable limit. Accordingly, although penetration of a laser having a further shorter wavelength and optimization of recording medium configuration appropriate to the laser have been energetically examined, actually considerable time will be necessary for practical application thereof. With the view of such circumstances, since application of multiphoton ionization; which is one of nonlinear optical effects, to an optical recording allows an optical recording medium to be recorded with a high capacity and a high recording density without requiring a short wavelength laser, it is expected as forming a novel basis of information processing technique.

The technique that is specifically proposed about the application to an optical recording in Patent Document 1 is stepwise two-photon ionization (ionization through a stepwise two-photon process) employing a nanosecond laser (a laser having a pulse width of nanosecond unit.) This includes such steps as irradiating a dye molecule dispersed in a polymer solid with a laser light having a wavelength corresponding to a S₀ state (ground state)—an S₁ state (lowest excited singlet state) to allow the dye molecule to absorb one photon to be excited, and allow the dye molecule to further stepwise absorb an additional photon in the excited S₁ state or in a T₁ state (lowest excited triplet state) generated from the S₁ state through intersystem crossing to allow the dye molecule to obtain energy beyond the Ip (refer to FIG. 20). Since the dye molecule absorbs energy 2 times the photon corresponding to the wavelength of the irradiated laser light, irradiation of light having a long wavelength where no absorption by the polymer solid occurs can selectively ionize the dye molecule.

Further, since the probability of occurrence of two-photon absorption is proportional to the square of a light intensity of an irradiating-laser, a spot within which the ionization reaction occurs has a sharp shape narrowed down compared with the intensity distribution of the laser light used. From the two-dimensional viewpoint, this corresponds to further narrowing down a spatial spot of the laser light, thereby making an optical recording in a region smaller than the diffraction limit spot possible.

From the three-dimensional viewpoint, two-photon absorption occurs only in a minute region having a strong light intensity of a laser at a focal position of a laser light having been narrowed down with a lens, and two-photon absorption does not occur in regions apart from the focal position by any small distance, therefore, two-photon absorption can be selectively induced in any minute space. This means that an optical recording in the depth direction in three-dimensional space is possible.

Patent Document 1: JP-A-2004-71036

### DISCLOSURE OF THE INVENTION

### Problems that the Invention is to Solve

However, the present inventors have found out, as the result of detailed examination, that there are following problems in the application of stepwise two-photon ionization to an optical recording employing a nanosecond laser, which is proposed in Patent Document 1. That is, there are such problems that, when a nanosecond laser is used, since a process to be ionized in which a dye molecule further stepwise absorbs an additional photon in an S₁ state excited by absorbing one photon or in a T₁ state generated from the S₁ state through intersystem crossing and a process in which the excited dye molecule is quenched while emitting fluorescence and/or phosphorescence competitively occur within a time range of nanosecond, a radical cation can not be efficiently generated when the quenching process is dominant over the ionization process (refer to FIG. 20); that, when an electron acceptor is dispersed in a polymer solid for the purpose of allowing the generated radical cation and the electron to stay stably in order to maintain a stable charge separation state, since the S₁ state is subjected to quenching through electron transfer interaction with the electron acceptor, a radical cation can not be efficiently generated; that, further, since it is necessary to excite the absorption band of a dye molecule in the ground state in order to bring about stepwise two-photon ionization, dispersion of the dye molecule in a polymer solid in a high concentration does not allow an irradiated light to easily reach deep portion of the polymer sample because of light absorption of the dye molecule existing near the surface of the polymer sample, which limits an optical recording in the depth direction of the polymer sample to limit a three-dimensional recording.

In addition, although an optical recording within a region smaller than a diffraction limit spot is possible by inducing two-photon absorption, in order to realize a further high density recording, there is a desire for development of an optical recording technology employing a further narrowed down minute space.

Accordingly, the present invention aims to provide a method for efficiently multiphoton-ionizing an organic molecule supported by a solid-carrier.

### Means for Solving the Problems

A method for multiphoton-ionizing an organic molecule supported by a solid carrier according to the present invention accomplished on the basis of the above-described knowledge is characterized in that, as described in claim 1, the carrier supporting an organic molecule is irradiated with a laser light having a pulse width of less than 1 nanosecond.

The method described in claim 2 is characterized in that, in the method described in claim 1, the laser having a pulse width of less than 1 nanosecond is a picosecond laser or a femtosecond laser.

The method described in claim 3 is characterized in that, in the method described in claim 2, the femtosecond laser is selected from titanium-sapphire lasers, fiber lasers and ytterbium-tungsten lasers.

The method described in claim 4 is characterized in that, in the method described in claim 1, multiphoton ionization is three-or-more-photon ionization.

The method described in claim 5 is characterized in that, in the method described in claim 1, the Ip of the organic molecule is 5 eV or more.

The method described in claim 6 is characterized in that, in the method described in claim 5, the Ip of the organic molecule is 10 eV or less.

The method described in claim 7 is characterized in that, in the method described in claim 1, the organic molecule is a dye molecule having a reversible characteristic of coloring based on the change of the absorption band caused by the change into a radical cation through multiphoton ionization and discoloring through charge recombination.

The method described in claim 8 is characterized in that, in the method described in claim 7, a laser light having a wavelength longer than the absorption band of the dye molecule in the ground state is irradiated.

The method described in claim 9 is characterized in that, in the method described in claim 8, a laser light having a wavelength of 530-1600 nm is irradiated.

The method described in claim 10 is characterized in that, in the method described in claim 1, the solid carrier is a polymer material.

The method described in claim 11 is characterized in that, in the method described in claim 10, the polymer material has at least one electrophilic functional group.

The method described in claim 12 is characterized in that, in the method described in claim 11, the elecrophilic functional group is at least one kind selected from a carbonyl group, a carboxyl group, an ester group, a cyano group, an imido group, a nitro group and a hydroxyl group.

The method described in claim 13 is characterized in that, in the method described in claim 1, the solid carrier is composed by further supporting an electron acceptor.

The method described in claim 14 is characterized in that, in the method described in claim 1, multiphoton ionization is simultaneous multiphoton ionization.

A method for multiphoton-ionizing a dye molecule supported by a solid carrier according to the present invention is characterized in that, as described in claim 15, multiphoton ionization is carried out through multiphoton ionization of three-or-more-photon ionization by irradiating the carrier supporting a dye molecule with a laser light having a wavelength longer than the absorption band of the dye molecule in the ground state.

The method described in claim 16 is characterized in that, in the method described in claim 15, multiphoton ionization is simultaneous four-photon ionization.

An optical recording system based on multiphoton ionization photochromism according to the present invention is characterized, as described in claim 17, by comprising at least a solid carrier supporting a dye molecule having a reversible characteristic of coloring based on the change of the absorption band caused by the change into a radical cation through multiphoton ionization and discoloring through charge recombination, and a laser wherein the carrier supporting a dye molecule is irradiated with a laser light having a wavelength longer than the absorption band of the dye molecule in the ground state to generate a radical cation of the dye molecule through multiphoton ionization of three-or-more-photon ionization to carry out recording/erasing while utilizing the reversible coloring and discoloring by the radical cation.

The optical recording system described in claim 18 is characterized in that, in the optical recording system described in claim 17, the laser is a femtosecond laser.

The optical recording system described in claim 19 is characterized in that, in the optical recording system described in claim 18, the femtosecond laser is selected from titanium-sapphire lasers, fiber lasers and ytterbium-tungsten lasers.

An optical recording medium according to the present invention is characterized, as described in claim 20, by comprising a solid carrier supporting a dye molecule having a reversible characteristic of coloring based on the change of the absorption band caused by the change into a radical cation through multiphoton ionization and discoloring through charge recombination, and being applied to the optical recording system based on multiphoton ionization photochromism described in claim 17.

### EFFECT OF THE INVENTION

According to the present invention, a solid carrier supporting an organic molecule is irradiated with a laser (ultrashort pulse laser) light having a pulse width of less than 1 nanosecond, whereby it is possible, to bring about simultaneous multiphoton ionization wherein the organic molecule is allowed to simultaneously absorb 2 photons or more within irradiation pulse time to be ionized directly from the S₀ state without going through an S₁ state, instead of stepwise two-photon ionization, wherein an organic molecule is excited by absorbing one photon, and then, in an excited S₁ state or in a T₁ state generated from the S₁ state through intersystem crossing, the organic molecule is allowed to further stepwise absorb an additional photon to be ionized under the competition with the quenching process. Consequently, even when such electron acceptor as 1,2,4,5-tetracyanobenzene (TCNB) is additionally dispersed in a polymer solid, there is no such problem that a radical cation can not be efficiently generated due to quenching of the S₁ state through electron transfer interaction with the electron acceptor as is the case for stepwise two-photon ionization. Accordingly, multiphoton ionization of an organic molecule supported by a solid carrier can be efficiently induced.

### BRIEF DESCRIPTION OF THE DRAWINGS

FIG. 1 is a drawing showing the respective chemical structural formulae of dye molecules used in the Example.

FIG. 2 is a drawing showing the respective chemical structural formulae of polymers for a cast film used in the Example.

FIG. 3 is a drawing showing the relation between the respective absorption spectra of the dye molecules used in the ground state and the respective types and wavelengths of the lasers used in the Example.

FIG. 4 is a block diagram of a photon counting system used for measuring charge recombination emission in the Example.

FIG. 5 is the respective absorption spectra observed upon ionization using a nanosecond pulse laser in the Example.

FIG. 6 is a chart showing a mechanism of ionization when a picosecond pulse laser is used in the Example.

FIG. 7 is a chart showing a mechanism of ionization through a simultaneous two-photon process in the Example.

FIG. 8 is a chart showing a mechanism of ionization through a simultaneous multiphoton process (simultaneous four-photon process) in the Example.

FIG. 9 is a drawing showing a spatial distribution of electrons ejected from a TMB/PBMA cast film in the Example.

FIG. 10 is a drawing showing the difference in the ionization mechanism caused by the difference in pulse width in the Example.

FIG. 11 is a drawing showing the relation between the radical cation yield when various types of lasers are used and the existing concentration of the electron acceptor in the Example.

FIG. 12 is a chart showing a mechanism of ionization when a nanosecond pulse laser is used in the Example.

FIG. 13 is a chart showing a mechanism of ionization when an ultrashort pulse laser is used in the Example.

FIG. 14 is a drawing showing the relation between the type of polymer medium and the amount of charge recombination emission in the Example.

FIG. 15 shows the absorption spectra before and after temperature rising of a Pe/PMMA bulk sample having been subjected to four-photon ionization in the Example.

FIG. 16 shows a fundamental examination result about erasing an optical recording by electric field application in the Example.

FIG. 17 shows a scheme representing the influence of electric field on charge recombination in the Example.

FIG. 18 is a drawing showing an energy diagram of a one-photon process.

FIG. 19 is a drawing showing an energy diagram of a two-photon process.

FIG. 20 is a chart showing a mechanism of ionization through a stepwise two-photon process.

### BEST MODE FOR CARRYING OUT THE INVENTION

Examples of the laser having a pulse width of less than 1 nanosecond for use in the present invention include picosecond lasers (lasers having a pulse width of a picosecond unit, that is, a pulse width of 1 picosecond or more to less than 1 nanosecond) and femtosecond lasers (lasers having a pulse width of a femtosecond unit, that is, a pulse width of 1 femtosecond or more to less than 1 picosecond). As the picosecond laser, YAG lasers or the like can be used. As the femtosecond laser, titanium-sapphire lasers, fiber lasers (which may have been doped with a rare earth element such as medium, erbium, ytterbium, or the like), ytterbium-tungsten lasers and the like can be used.

Examples of the solid carrier supporting an organic molecule can include a polymer solid in which a dye molecule having an Ip of 5-10 eV is dispersed. When the dye molecule is selected to have a reversible characteristic of coloring based on the change of the absorption band caused by the change into a radical cation through multiphoton ionization and discoloring through charge recombination, while basing on the fact that a radical cation can be efficiently generated through simultaneous multiphoton ionization, it is possible to enhance applicability to an optical recording utilizing reversibility of photochromism (for example, increase in recording/erasing speed, enhancement of durability for repeating recording/erasing, and the like). In this case, examples of the method for accelerating charge recombination include electric field application and infrared ray irradiation, in addition to temperature rising of the polymer solid to near the glass transition temperature, each of which can be employed as a method for erasing an optical recording.

Among these, when a femtosecond laser is used, even if the laser is one having a wavelength that does not correspond to the absorption band of a dye molecule in the ground state (for example, such wavelength as 530-1600 nm, which is longer than the absorption band of the dye molecule in the ground state), a radical cation can be generated by allowing the dye. molecule to simultaneously absorb 3 photons or more within a time range of femtosecond to induce simultaneous multiphoton ionization of simultaneous three-or-more-photon ionization within a minute region having a strong light intensity of a laser at a focal position of a laser light having been narrowed down with a lens. This phenomenon is very important for accomplishing high capacity/high recording density of an optical recording medium. That is, in stepwise two-photon ionization, since it is necessary to excite the absorption band of a dye molecule in the ground state, when the dye molecule is dispersed in a polymer solid in a high concentration so as to increase the radical cation yield in order to obtain sufficient coloring, the dye molecule existing near the surface of the polymer sample absorbs light to color the polymer sample in a limited area near the surface thereof through ionization of the dye molecule. Accordingly, since irradiated light hardly reaches a deep portion of a polymer sample in stepwise two-photon ionization, an optical recording in the depth direction of a polymer sample is limited to limit three-dimensional recording. However, when a radical cation can be generated through simultaneous multiphoton ionization, since excitation of the absorption band of a dye molecule in the ground state is not necessary, there is no such problem as described above that occurs in stepwise two-photon ionization, thereby making it possible to enhance recording density in three-dimensional recording. In addition, when a femtosecond laser is used, such ionization design is possible that, while taking the Ip of a dye molecule into consideration, the Ip is divided by an intended n number and carries out corresponding n-photon ionization to generate a radical cation. Further, since irradiation time of a laser light is extremely short, degradation of polymer by irradiation of the laser light can be inhibited or decreased.

When four-photon ionization is assumed, since it makes local ionization largely surpassing local ionization through. two-photon ionization possible, capacity/recording density of an optical recording medium can be enhanced dramatically. In other words, in four-photon ionization, as compared with two-photon ionization, a stronger non-linearity relative to irradiation light density appears to make it possible to narrow down the spot to a smaller size. Further, it is sufficient that the Ip is equal to an energy level 4 times the energy of photon used, thus even a laser having a wavelength not corresponding to the absorption band of a dye molecule in the ground state can ionize the dye molecule. In order to realize four-photon ionization of a dye molecule having an Ip of 5-10 eV, a laser light to be used is required to have not only an extremely short pulse width but also an extremely high light density, and since a regenerative amplified light of a titanium-sapphire laser, which is a femtosecond laser, satisfies both of the above two requirements, it is a preferable laser. Further, by quadrisecting an Ip, it is possible to further inhibit or decrease degradation of polymer through irradiation of the laser light.

Specific examples of the dye molecule having a reversible characteristic of coloring based on the change of the absorption band caused by the change into a radical cation through multiphoton ionization and discoloring through charge recombination include such dye molecules having an Ip of 5-10 eV as phenylenediamine-based dyes, carbazole-based dyes, perylene-based dyes, benzidine-based dyes, thiophene-based dyes, biphenyl-based dyes, benzene-based dyes, pyrene-based dyes, quinoline complex dyes, phenanthroline complex dyes, macrocyclic azaannulene-based dyes (phthalocyanine dye, naphthalocyanine dye, porphyrin dye and the like), polymethine-based dyes (cyanine dye, merocyanine dye, squarylium dye and the like), anthraquinone-based dyes, azulenium-based dyes, azo-based dyes, indoaniline-based dyes, pyrromethene-based dyes, coumarin-based dyes, rhodamine-based dyes, stilbene-based dyes, oxadiazole-based dyes, dendrimer-based dyes and metal complex-based dyes. Among these, desirable examples include dye molecules having D-π-D type structure, dye molecules having D-π-A type structure, dye molecules having A-π-A type structure, which are dye molecules having a long effective conjugation length and high polarizability while having, for example, an electron donating (D) group such as a triphenyl amino group, an electron accepting (A) group such as an oxadiazolyl group or a terephthaloyl group, or a stilbene derivative (π) that extends an effective n conjugation length in the skeleton, and dye molecules composed of a multi-branched derivative thereof. The dye molecule may be dispersed in a polymer solid in only one type, or in a mixture of plural types. The dye molecule is desirably dispersed so as to give a concentration of 10⁻⁴−5 mol/L in the polymer solid.

The polymer material used for dispersing a dye molecule is desirably one that has no absorption band overlapping the absorption band of the dye molecule in the ground state and has such highly electrophilic functional group as a carbonyl group, a carboxyl group, an ester group, a cyano group, an imido group, a nitro group or a hydroxyl group so as to trap an electron ejected from the dye molecule to allow the electron to exist stably. In addition, in order to keep a record stably for a long time, such polymer material is desirable that has a high glass transition temperature not to be accompanied with sub-relaxation such as side chain relaxation. Specific examples include poly(alkyl methacrylates) such as poly(methyl methacrylate) (PMMA), polycarbonates, polyethylene terephthalates, polyimides, polyesters, polyvinyl chlorides, polyvinyl acetates, cyanocelluloses, cyanopullulans, polymethacrylonitriles and polyvinyl alcohols. The polymer material may be a copolymer composed of plural monomer components or a polymer blend composed of plural polymers.

A polymer solid in which a dye molecule is dispersed may be produced, for example, by polymerizing a monomer to which a dye molecule has been added, or by adding a dye molecule to a polymer material dissolved in an organic solvent. When shaping a polymer solid in which a dye molecule is dispersed, it may be carried out according to a publicity known method such as a cast method, a hot-melt method or an injection molding method.

Incidentally, the solid carrier supporting an organic molecule is not limited to a polymer solid in which a dye molecule is dispersed as described above, but, as a solid carrier in which a dye molecule is dispersed, a solid medium may be used instead of a polymer material, including an inorganic substance such as borate glass, a porous inorganic substance such as zeolite, an inorganic layered crystalline substance such as montmorillonite, a blended substance of these inorganic substances and a polymer material, and a polymer material-inorganic hybrid substance. As to a method of allowing a solid carrier to support a dye molecule, when the solid carrier is made of a polymer material, instead of a method in which a dye molecule is dispersed in the solid carrier, such method may be used in which a dye molecule is directly introduced to a main chain or a side chain of the polymer material via a chemical bond, or a layer consisting of a dye molecule (which may be a coated layer, or a layer of single crystal of a dye molecule) is formed on the surface of the solid carrier.

Furthermore, a multiphoton ionization method of the present invention can be applied to an optical processing technology based on the fact that a radical cation generated through multiphoton ionization of an organic molecule becomes a chemical reaction species (for example, use of a polymer solid in which an organic molecule is dispersed as a resist).

### EXAMPLES

Hereinafter, the present invention will be described in further details referring to the Examples, but the present invention is not construed to be limited to the following description.

### A. Samples Used in the Experiment

### (1) Dye Molecule

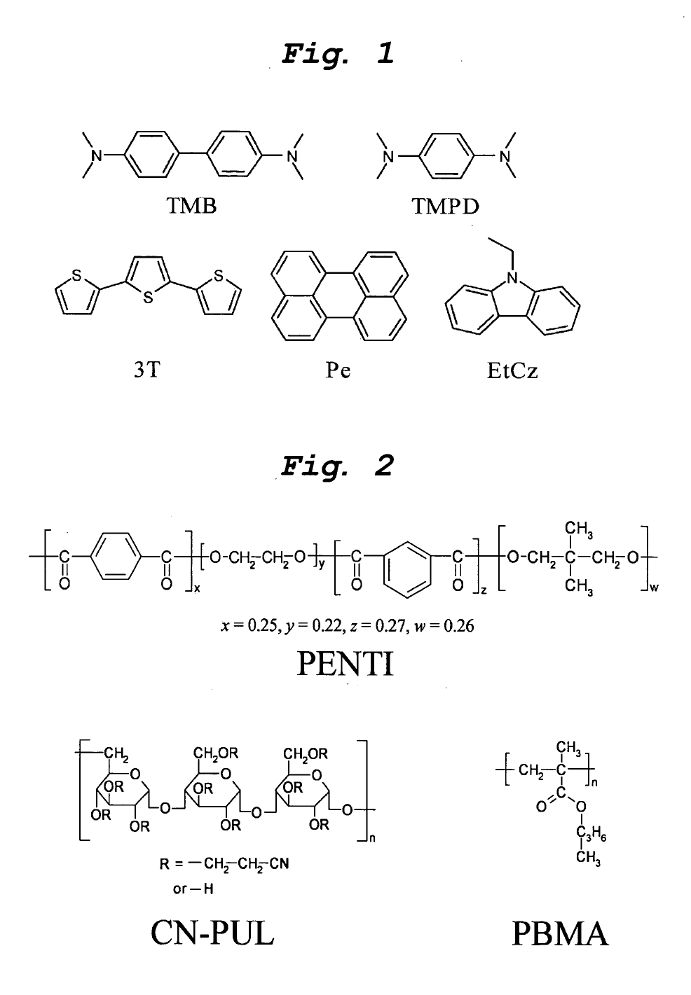

N,N,N′,N′-tetramethylbenzidine (TMB: 6.8 eV), N,N,N′,N′-tetramethyl-p-phenylenediamine (TMPD: 6.7 eV), terthiophene (3T: 7.4 ev), perylene (Pe: 6.9 eV), or N-ethylcarbazole(EtCz: 7.7 eV) was used (numeric values in parentheses represent the Ip in vapor phase) These chemical structural formulae are shown in FIG. 1.

### (2) Polymer

(a) Monomer Used for Manufacturing a Polymer Solid (Bulk Sample)

Commercially available highest quality methyl methacrylate (MMA) was used after washing twice with a 5% aqueous sodium hydroxide solution and 4 times with a 20% brine solution followed by drying overnight by adding anhydrous sodium sulfate, and then purifying the same by carrying out vacuum distillation (temperature: 40° C., pressure: 110 mmHg)

(b) Polymer for a Cast Film

For measurement of charge recombination emission, a film sample was used. On this occasion, as a polymer, polyester having a terephthalbyl group being an electron accepting group in a main chain (PENTI, poly[(ethylene glycol; neopentyl glycol)-alt-(terephthalic acid; isophthalic acid)]) was used. In addition, in order to examine difference in the radical cation yield depending on polymer types, cyanopullulan having a cyano group with high polarity in a side chain (CN-PUL, cyanoethylated pullulan) and poly(butyl methacrylate) (PSMA) having an ester group in a side chain were used for comparison. These chemical structural formulae are shown in FIG. 2.

### B. Preparation of a Sample

### (1) Manufacture of a Bulk Sample

To the purified MMA, 2,2′-azobisisobutyronitrile was added as a polymerization initiator so as to give a resulting concentration of 5×10⁻⁴ mol/L, to which respective dye molecules shown in FIG. 1 were added. Respective monomer solutions were charged in respective Pyrex (registered trade mark) cells, which were sealed after being subjected to deaeration 5 times by a freeze-pump-thaw method using a vacuum line and used for manufacturing PMMA bulk samples by a mass polymerization method. The polymerization was carried out at 60° C. for 12 hours, at 70° C. for 12 hours and at 120° C. for 12 hours. In this case, the dye molecule was added so as to give resulting OD of about 1.0 at the exciting wavelength (which corresponded to 10⁻⁴-10⁻³ mol/L as the concentration in the bulk sample)

### (2) Manufacture of a Cast Film

Respective polymers shown in FIG. 2 were dissolved in an organic solvent, to each of which was added various types of dye molecules respectively to be used for manufacturing a film sample having a thickness of about 50 μm by a cast method on a surface of a quartz substrate. Concentration of the dye molecule in the cast film was determined to be 10⁻³ mol/L in order to eliminate intermolecular interaction.

### (3) Laser

Such lasers were used as an excimer laser having a wavelength of 351 nm with a pulse width of 20 ns (nanosecond laser), Nd:YAG lasers having a wavelength of 355, 532 or 1064 nm with a pulse width of 20 ps (picosecond laser), and titanium-sapphire lasers having a wavelength of 400 or 800 nm with a pulse width of 100 fs (femtosecond laser)

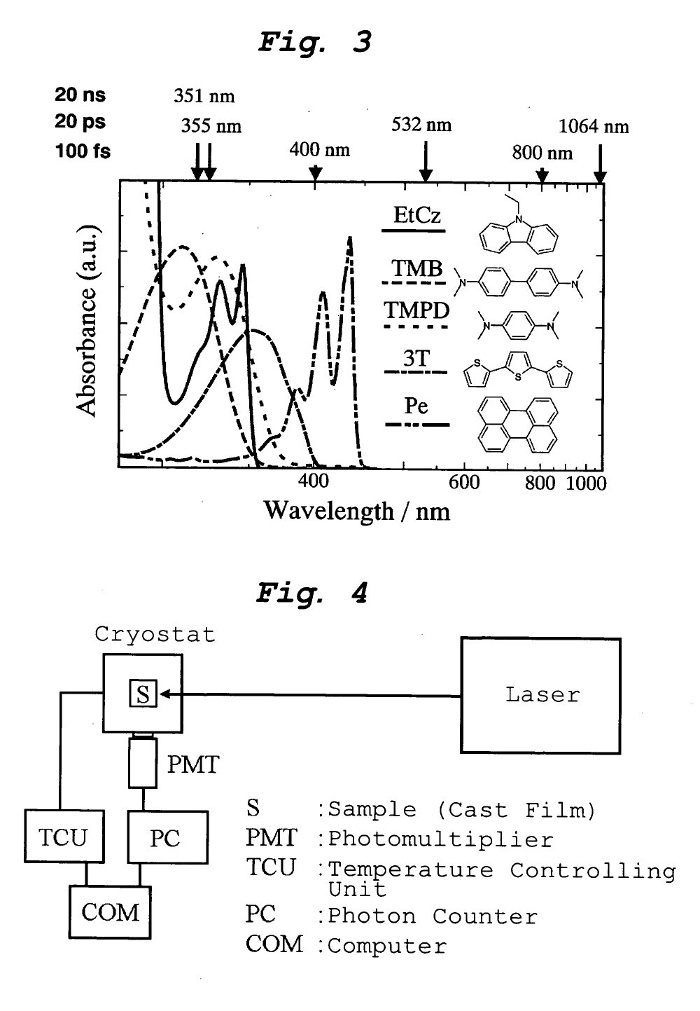

The relation between the respective absorption spectra of the dye molecules used in the ground state and the respective types and wavelengths of the lasers used is shown in FIG. 3. The relation between them is that each dye molecule has absorption at the wavelengths of 351 nm of the nanosecond laser and 355 nm of the picosecond laser, Pe and 3T have absorption at the wavelength of 400 nm of the femtosecond laser, and that no dye molecule has absorption at other wavelengths.

### (4) Measuring Method and Measuring Apparatus

(a) Measurement of Multiphoton Ionization

A radical cation generated through multiphoton ionization by irradiating various types of laser lights to the bulk sample was measured by measurement of the absorption spectrum (spectrophotometer U-3500) in the steady state.

(b) Measurement of Charge Recombination Emission

A quartz substrate, on the surface of which a cast film had been manufactured, was fixed to a cold finger in a cryostat to be cooled to 20 K under a reduced pressure, followed by only one shot irradiation of a laser pulse light. Then, from immediately after the irradiation, charge recombination emission was observed with a photon counting system shown in FIG. 4.

### C. Difference in Behavior of Ionizing a Dye Molecule Due to Difference in Pulse Width of a Laser Used.

### (1) Ionization when a Nanosecond Pulse Laser is Used

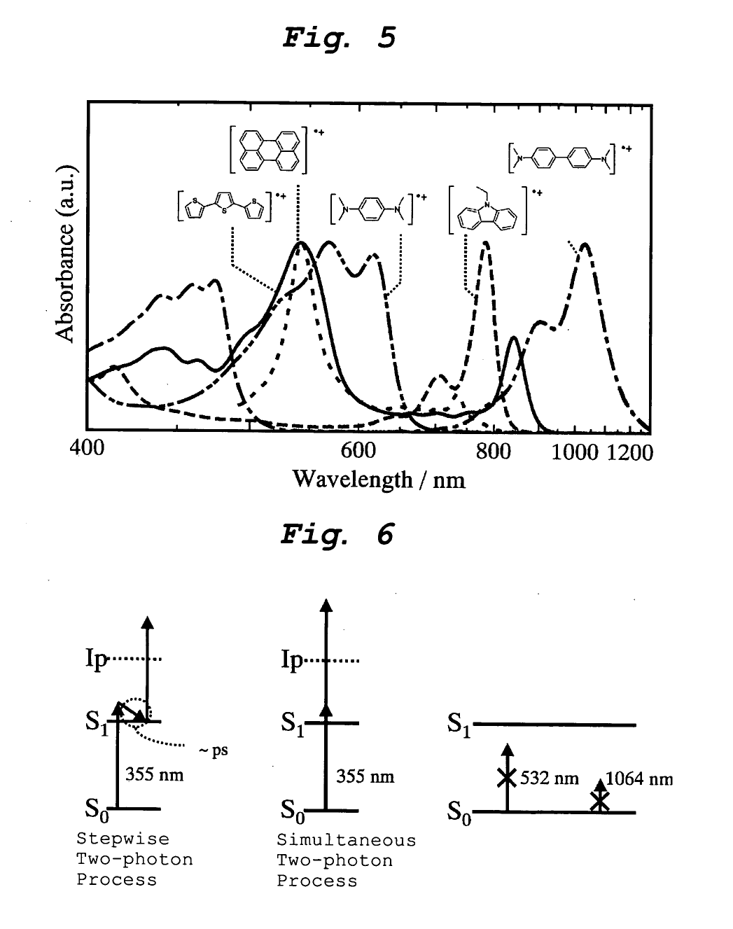

When a nanosecond laser light having a wavelength of 351 nm (3.53 eV) was irradiated to a bulk sample, a radical cation was generated in all the types of bulk samples, thereby making it possible to monitor an-absorption band attributable to the radical cation in a visible to near-infrared region for every dye molecule. The observed absorption spectrum is shown in FIG. 5. This is thought to be attributable to ionization through a stepwise two-photon process wherein a process to be ionized in which a dye molecule further stepwise absorbs an additional photon in an S₁ state excited by absorbing one photon or in a T₁ state generated from the S₁ state through intersystem crossing and a process in which the excited dye molecule is quenched while emitting fluorescence and/or phosphorescence competitively occur within a time range of nanosecond (refer to FIG. 20).

### (2) Ionization when a Picosecond Pulse Laser is Used

When a picosecond laser light having a wavelength of 355 nm (3.49 eV) was irradiated to a bulk sample, a radical cation was generated in all the types of bulk samples, thereby making it possible to monitor an absorption band attributable to the radical cation in a visible to near-infrared region for every dye molecule. This is thought, in ionization by picosecond pulse, since an ionization process competes with vibrational relaxation in such time range as picosecond, to be attributable to ionization through a simultaneous two-photon process wherein ionization occurs by absorbing further an additional photon without relaxation from a high vibrational level of the S₁ state, in addition to ionization through a stepwise two-photon process. When a picosecond laser light having a wavelength of 532 nm (2.33 eV) or 1064 nm (1.17 eV) was irradiated to a bulk sample, no absorption band attributable to a radical cation was monitored in a visible to near-infrared region for every type of bulk sample. This is thought to be attributable to the fact that the dye molecule has no absorption at these wavelengths (refer to FIG. 6). Incidentally, when a similar experiment was carried out with a further increased laser light intensity, crack was generated in the bulk sample.

### (3) Ionization when a Femtosecond Pulse Laser is Used

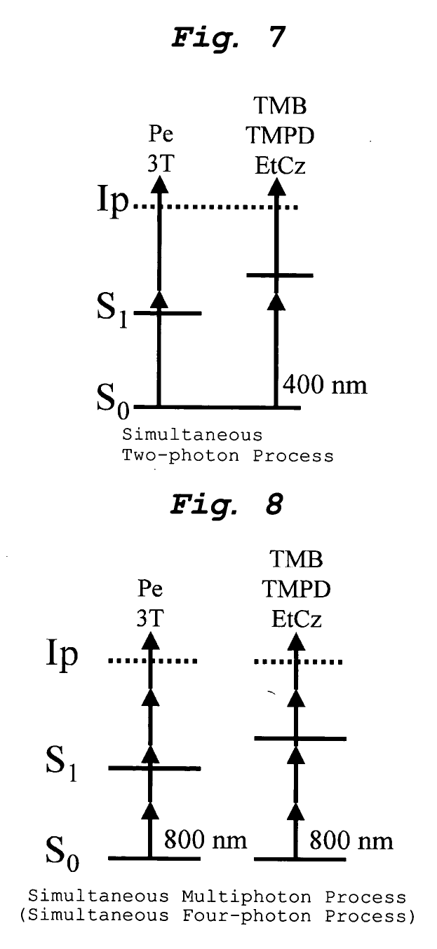

When a femtosecond laser light having a wavelength of 400 nm (3.10 eV) was irradiated to a bulk sample, a radical cation was generated in all the types of bulk samples, thereby making it possible to monitor an absorption band attributable to the radical cation in a visible to near-infrared region even for TMB, TMPD and EtCz having no absorption at a wavelength of 400 nm, as well as for Pe and 3T having absorption at the wavelength. Since there exists no primary quenching process that competes with an ionization process in a time range of femtosecond, this is thought to be attributable to generation of a radical cation through ionization, for Pe and 3T having absorption at a wavelength of 400 nm, through a simultaneous two-photon process resonating to a high vibrational level of. the S₁ state, and ionization, for TMB, TMPD and EtCz having no absorption at the wavelength, through a non-resonant simultaneous two-photon process via a virtual intermediate state close to the S₁ state (refer to FIG. 7).

Even when a femtosecond laser light having a wavelength of 800 nm (1.55 eV) was irradiated to a bulk sample, a radical cation was generated in all the types of bulk samples, thereby making it possible to monitor an absorption band attributable to the radical cation in a visible to near-infrared region also for every dye molecule having no absorption at a wavelength of 800 nm. This is thought to be attributable to generation of a radical cation through ionization through a simultaneous multiphoton process of 4 photons or more in a time range of femtosecond (refer to FIG. 8).

From the above-described results, it was found that simultaneous multiphoton ionization can be efficiently brought about at a wavelength at which a dye molecule has no absorption by using a femtosecond laser as an ultrashort pulse laser.

### (4) Difference in Spatial Distribution of Electrons Ejected from a Dye Molecule Due to Difference in Pulse Width of a Laser Used

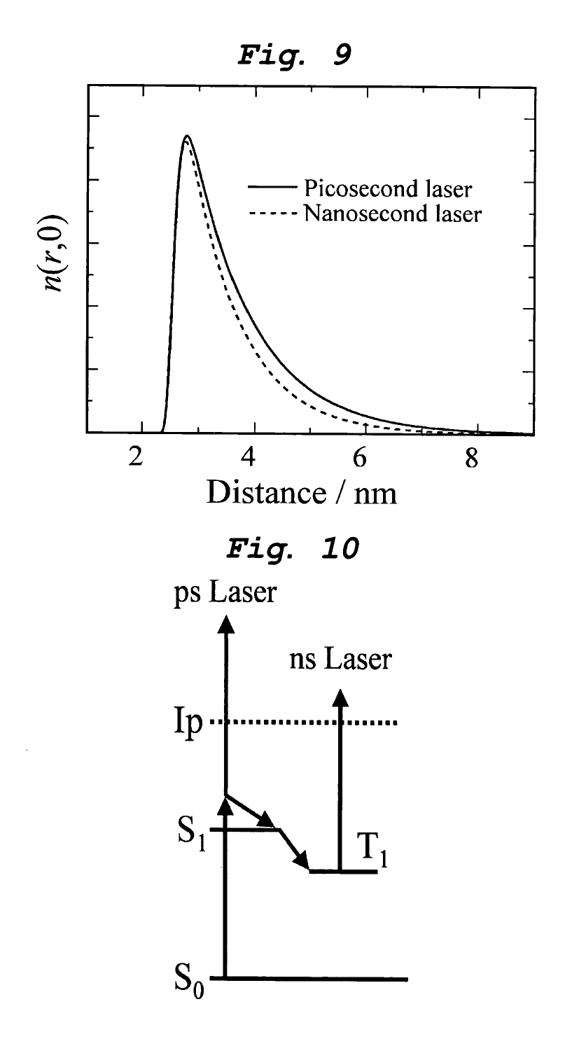

The THB/PBMA cast film was irradiated with a nanosecond laser light-having a wavelength of 351 nm and a picosecond laser light having a wavelength of 355 nm respectively to generate a TMB radical cation and to make TMB eject an electron, and charge recombination emission resulting from these was observed to give a spatial distribution function of ejected electrons in PBMA at 100 seconds after the irradiation according to time evolution of emission intensity. As the result, as shown in FIG. 9, it, was found that distribution of ejected electrons extended wider when the picosecond laser light was irradiated compared with the case where the nanosecond laser light was irradiated. This is thought to be attributable to the phenomenon that, when a nanosecond laser light is irradiated, after TMB absorbs one photon to be excited to an S₁ state, relaxation occurs to a T₁ state generated from the S₁ state through intersystem crossing, and then it further stepwise absorbs, an additional photon, and that, on the other hand, when a picosecond laser light having a narrower pulse width and a higher photon density compared with a nanosecond laser light is irradiated, it can absorb one additional photon before relaxation occurs from the S₁ state to the T₁ state, thereby resulting in no energy loss through intersystem crossing to allow the ejected electron with larger excess energy to be widely distributed far away (refer to FIG. 10)

### D. Electron Trapping Effect:

### (1) Difference in Effect Due to Difference in Pulse Width of a Laser Used

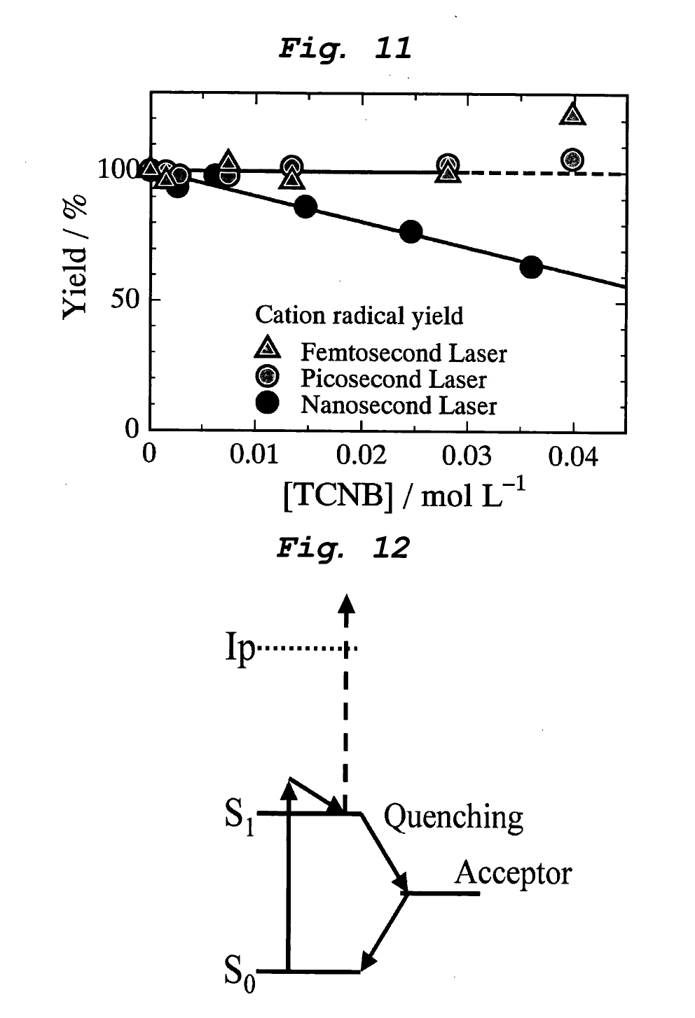

The yield of radical cations, which were generated by irradiating a nanosecond laser light having a wavelength of 351 nm, a picosecond laser light having a wavelength of 355 nm and a femtosecond laser light having a wavelength of 400 nm, respectively, to total 7 types of samples manufactured by adding TCNB as an electron acceptor in concentration of 6 levels (0.0012, 0.0024, 0.0060, 0.0120, 0.0240 and 0.0360 mol/L) and adding no TCNB upon manufacture of TMPD/PMMA bulk samples, was examined. The result is shown in FIG. 11.

As is clear from FIG. 11, when the nanosecond laser light was irradiated, the radical-cation yield decreased along with the increase in the electron acceptor concentration. This is thought to be attributable to quenching of the S₁ state through electron transfer interaction with the electron acceptor (refer to FIG. 12).

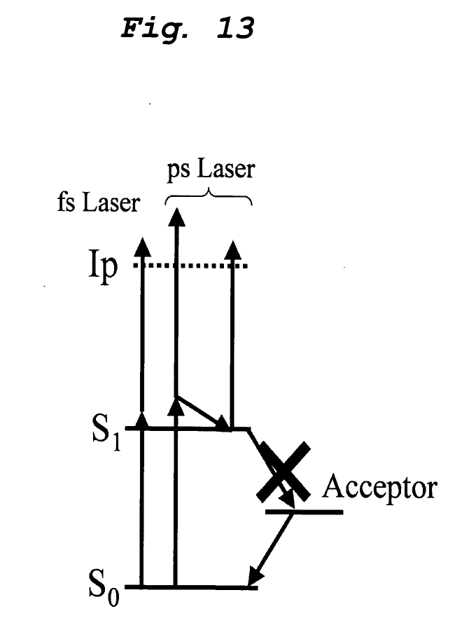

When the picosecond laser light was irradiated, the radical cation yield did not decrease even when the electron acceptor concentration increased. This is thought to show such phenomenon that no quenching of the S₁ state by the electron acceptor occurs in ionization through a simultaneous two-photon process and, in addition, no quenching of the S₁ state by the electron acceptor occurs also in ionization through a stepwise two.-photon process (refer to FIG. 13).

When the femtosecond laser light was irradiated, as was the case for irradiating the picosecond laser light, the radical cation yield did not decrease even when the electron acceptor concentration increased. Furthermore, not only the radical cation yield did not decrease, but also the tendency of the increase in the radical cation yield was found along with the increase in the electron acceptor concentration. This is thought to be attributable to no occurrence of quenching of the S₁ state by the electron acceptor and, in addition, the efficient occurrence of ionization because of a higher electron trapping property of the electron acceptor compared with the polymer medium (refer to FIG. 13).

### (2) Influence of a Polymer Medium on an Ejected Electron

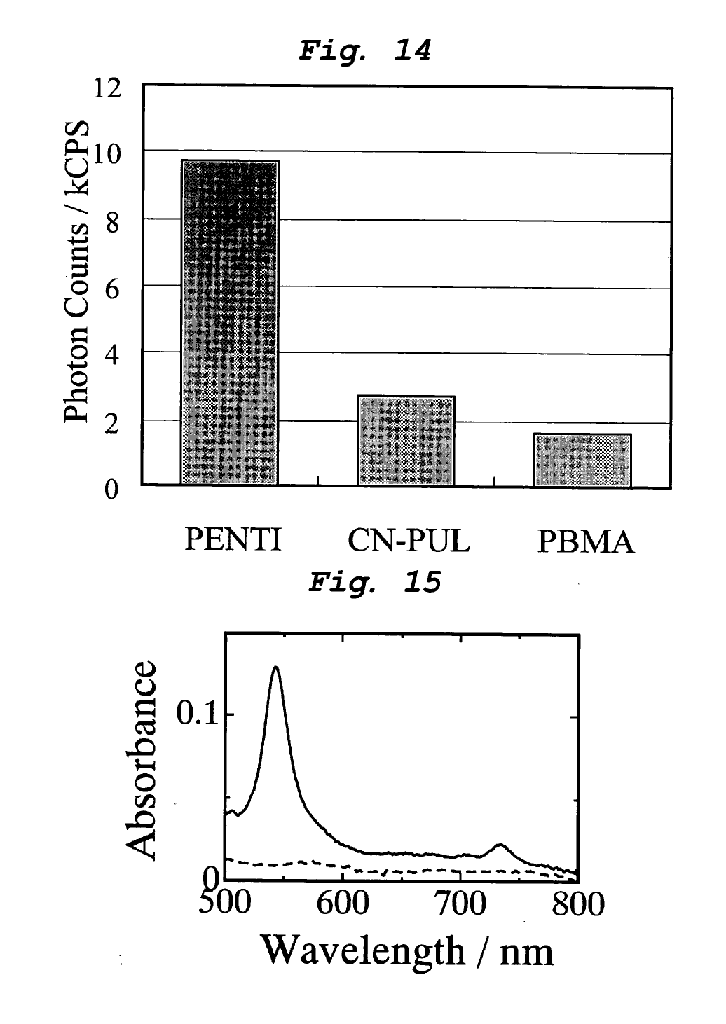

A cast film manufactured by using Fe as a dye molecule was irradiated with a picosecond laser light having a wavelength of 355 nm to generate a Pe radical cation and to make Pe eject an electron, and charge recombination emission resulting from these was observed to obtain emission amount at 100 seconds after the irradiation. The result is shown in FIG. 14 As is clear from FIG. 14, since the emission amount and the radical cation yield are proportional to each other, it was found that, by using a polymer material such as PENTI having a terephthaloyl group as an electron accepting group in a main chain, the radical cation yield at a temperature at which the motion of the polymer chain froze could be increased dramatically.

### E. Optical Recording by Simultaneous-Four-Photon Ionization

### (1) Comparison of Optical Recordings in the Depth Direction of a Sample Due to Difference in Excitation Wavelength

Respective coloring states when the Pe/PMMA bulk sample was irradiated with a picosecond laser light having a wavelength of 355 nm and with a femtosecond laser light having a wavelength of 800 nm were compared. As the result, when the picosecond laser light was irradiated, purple-red coloring derived from a Pe radical cation was observed near the surface of the bulk sample irradiated with the laser light. On the contrary, when the femtosecond laser light was irradiated, corresponding to the focal position of the laser light, purple-red coloring derived from the Pe radical cation was observed not only near the surface but also at a location starting from the surface into the depth of the sample. This result shows that an optical recording is possible not only on the surface but also in the inside of a sample even having a large thickness by utilizing four-photon ionization through excitation of a dye molecule with light of wavelength that is not absorbed by the dye molecule and controlling the focal position of the laser light.

### (2) Erasing of an Optical Recording by Temperature Rising

An absorption spectrum of the Pe/PMMA bulk sample colored in purple-red by irradiating a femtosecond laser light having a wavelength of 800 nm is shown in FIG. 15 in solid line. A peak near 545 nm is attributable to a Pe radical cation, and the absorption band hardly decayed at room temperature and observed over a long time. When the bulk sample was heated to 130° C., which is higher than the glass transition temperature (110° C.) of PMMA, the purple-red coloring disappeared. The dashed line in FIG. 15 is an absorption spectrum measured after the heating. When such irradiation of laser light and temperature rising were repeated, the coloring and discoloring were observed repeatedly. This result shows that coloring based on the change of the absorption band caused by the change of a dye molecule into a radical cation through four-photon ionization and discoloring resulting from return to the dye molecule as before through charge recombination induced by the temperature rising occur reversibly. Accordingly, by utilizing the phenomenon, recording/erasing in the optical recording system can be carried out repeatedly.

### (3) Erasing of an Optical Recording by Electric Field Application

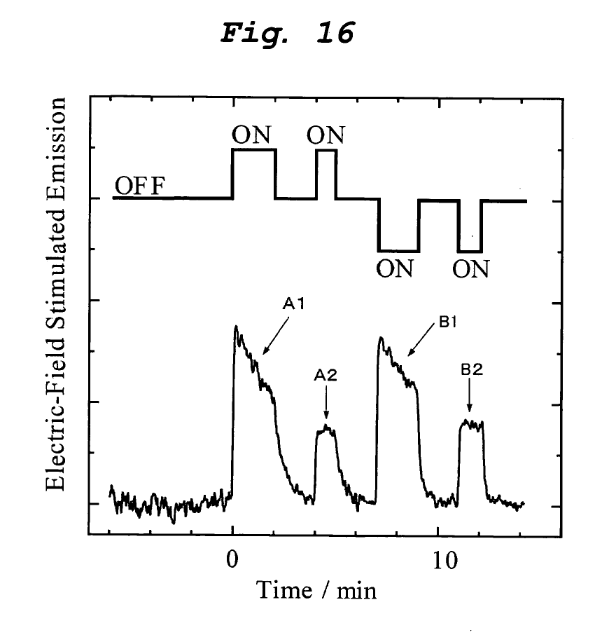

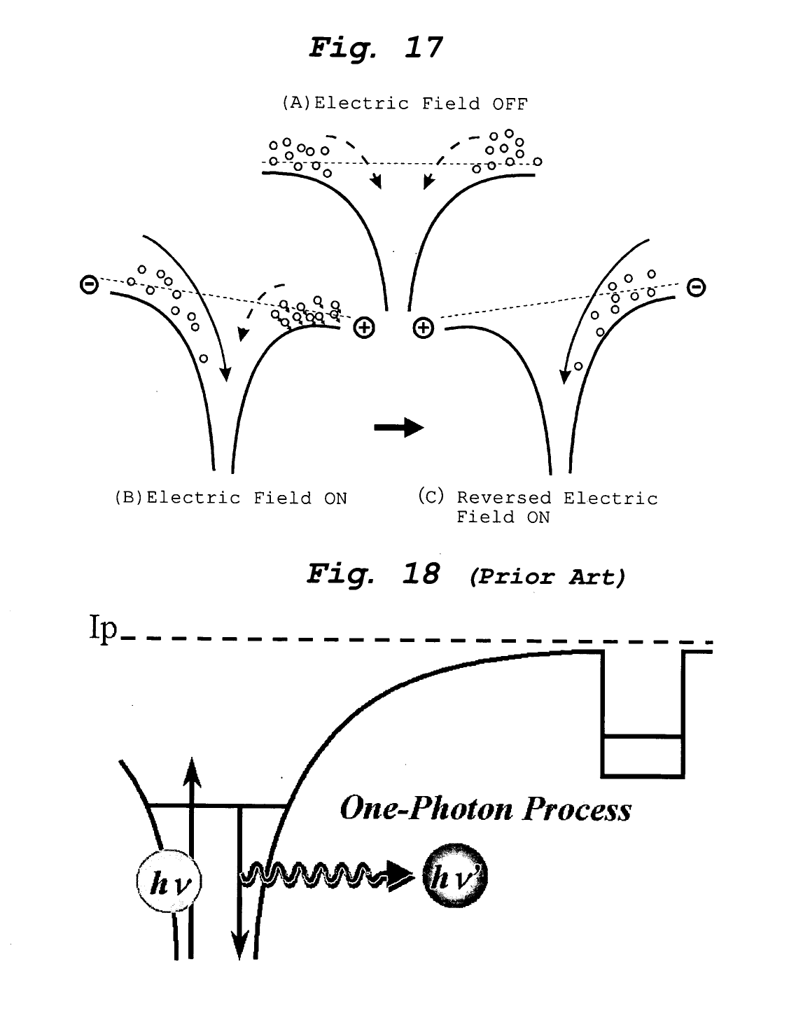

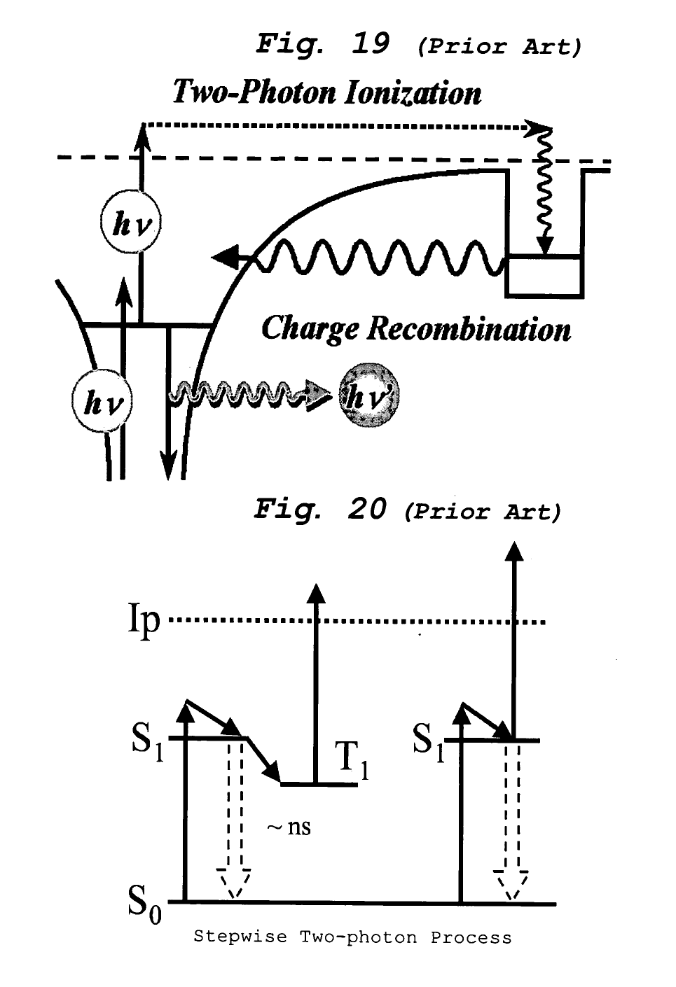

A fundamental examination of erasing of an optical recording by electric field application was carried out according to the following process. A benzene solution dissolving TMB and PMMA was cast on a glass substrate to give a TMB/PMMA film sample having a thickness of 74 μm. The film peeled off the glass substrate was sandwiched between the conductive surfaces of 2 transparent electrodes (NESA glass) having been equipped with a lead, which was dipped in liquid nitrogen to be cooled to 77 K. An excimer laser light having a wavelength of 351 nm with a pulse width of 20 ns (nanosecond laser) was irradiated to generate a TMB radical cation. When emission of the film sample resulted from recombination of the ejected electron and the parent cation was measured by a single photon counting technique, by applying an electric field of 2×10⁵ V cm⁻¹ to the film sample, an electric-field-induced recombination emission was recognized (A1 peak in FIG. 16). After that, when an electric field was applied again, recombination emission was recognized (A2 peak), although smaller than the A1 peak. Next, when the sign of applying an electric field was reversed, recombination emission nearly equal to the A1 peak was recognized (B1 peak) Subsequently, when an reversed electric field was applied again, recombination emission nearly equal to the A2 peak was recognized (B2 peak). This phenomenon can be explained based on the scheme shown in FIG. 17. That is, when no electric field is applied, as shown in FIG. 17(A), isotropic charge recombination occurs. On the contrary, when an electric field is applied, as shown in FIG. 17(B), charge recombination is accelerated toward the electric field applying direction. When a reversed electric field is applied, as shown in FIG. 17(C), charge recombination is accelerated toward the reversed electric field directions The above-described result shows that charge recombination is accelerated by electric field application, whereby the radical cation returns to a neutral molecule as before. Accordingly, by utilizing the phenomenon, an optical recording by ionization can be erased by electric field application. Further, it is also possible to utilize recombination emission induced by electric field application as a read signal of an optical recording. Incidentally, in this fundamental examination, ionization of TMB was carried out by using a nanosecond laser, however, even if ionization is carried out by using a picosecond laser or a femtosecond laser, the scheme of an electric-field-induced recombination emission is not different.

### (4) Difference in Recording Spot Sizes in Four-Photon Ionization and Two-Photon Ionization

When the Pe/EMMA bulk sample was irradiated with a focused picosecond laser light having a wavelength of 355 nm or a focused femtosecond laser light having a wavelength of 800 nm, the spot size of the latter case was ⅔ or less as compared with that of the former case. Since a Pe radical cation generates through two-photon ionization in the case of 355 nm excitation by using the picosecond laser, and a Pe radical cation generates through four-photon ionization in the case of 800 nm excitation by using the femtosecond laser, this result shows that four-photon ionization can carry out a finer optical recording than two-photon ionization.

### INDUSTRIAL APPLICABILITY

The present invention has industrial applicability in that it can provide a method for efficiently multiphoton-ionizing an organic molecule supported by a solid carrier. According to the present invention, it is possible to supply an optical recording system based on multiphoton ionization photochromism characterized by comprising at least a solid carrier supporting a dye molecule having a reversible characteristic of coloring based on the change of the absorption band caused by the change into a radical cation through multiphoton ionization and discoloring through charge recombination, and a laser, wherein the carrier supporting a dye molecule is irradiated with a laser light having a wavelength longer than the absorption band of the dye molecule in the ground state to generate a radical cation of the dye molecule through multiphoton ionization of three-or-more-photon ionization to carry out recording/erasing while utilizing the reversible coloring and discoloring by the radical cation.

1. A method for multiphoton-ionizing an organic molecule supported by a solid carrier, characterized in that the carrier supporting an organic molecule is irradiated with a laser light having a pulse width of less than 1 nanosecond.

2. The method according to claim 1, characterized in that the laser having a pulse width of less than 1 nanosecond is a picosecond laser or a femtosecond laser.

3. The method according to claim 2, characterized in that the femtosecond laser is selected from titanium-sapphire lasers, fiber lasers and ytterbium-tungsten lasers.

4. The method according to claim 1, characterized in that multiphoton ionization is three-or-more-photon ionization.

5. The method according to claim 1, characterized in that the ionization potential of the organic molecule is 5 eV or more.

6. The method according to claim 5, characterized in that the ionization potential of the organic molecule is 10 eV or less.

7. The method according to claim 1, characterized in that the organic molecule is a dye molecule having a reversible characteristic of coloring based on the change of the absorption band caused by the change into a radical cation through multiphoton ionization and discoloring through charge recombination.

8. The method according to claim 7, characterized in that a laser light having a wavelength longer than the absorption band of the dye molecule in the ground state is irradiated.

9. The method according to claim 8, characterized in that a laser light having a wavelength of 530-1600 nm is irradiated.

10. The method according to claim 1, characterized in that the solid carrier is a polymer material.

11. The method according to claim 10, characterized in that the polymer material has at least one electrophilic functional group.

12. The method according to claim 11, characterized in that the elecrophilic functional group is at least one kind selected from a carbonyl group, a carboxyl group, an ester group, a cyano group, an imido group, a nitro group and a hydroxyl group.

13. The method according to claim 1, characterized in that the solid carrier is composed by further supporting an electron acceptor.

14. The method according to claim 1, characterized in that multiphoton ionization is simultaneous multiphoton ionization.

15. A method for multiphoton-ionizing a dye molecule supported by a solid carrier, characterized in that multiphoton ionization is carried out through multiphoton ionization of three-or-more-photon ionization by irradiating the carrier supporting a dye molecule with a laser light having a wavelength longer than the absorption band of the dye molecule in the ground state.

16. The method according to claim 15, characterized in that multiphoton ionization is simultaneous four-photon ionization.

17. An optical recording system based on multiphoton ionization photochromism, characterized by comprising at least a solid carrier supporting a dye molecule having a reversible characteristic of coloring based on the change of the absorption band caused by the change into a radical cation through multiphoton ionization and discoloring through charge recombination, and a laser, wherein the carrier supporting a dye molecule is irradiated with a laser light having a wavelength longer than the absorption band of the dye molecule in the ground state to generate a radical cation of the dye molecule through multiphoton ionization of three-or-more-photon ionization to carry out recording/erasing while utilizing the reversible coloring and discoloring by the radical cation.

18. The optical recording system according to claim 17, characterized in that the laser is a femtosecond laser.

19. The optical recording system according to claim 18, characterized in that the femtosecond laser is selected from titanium-sapphire lasers, fiber lasers and ytterbium-tungsten lasers.

20. An optical recording medium, characterized by ,comprising a solid carrier supporting a dye molecule having a reversible characteristic of coloring based on the change of the absorption band caused by the change into a radical cation through multiphoton ionization and discoloring through charge recombination, and being applied to the optical recording system based on multiphoton ionization photochromism described in claim 17.
